(19) United States
(12) Patent Application Publication
(10) Pub. No.: US 2008/0136956 A1
(43) Pub. Date: Jun. 12, 2008

(54) Internal noise reducing structures in camera systems employing an optics stack and associated methods

(75) Inventors: James Morris, Lake Wylie, SC (US); Robert TeKolste, Charlotte, NC (US); Hongtao Han, Mooresville, NC (US); Greg Kintz, Asheville, NC (US); Paul Elliot, Charlotte, NC (US); Jeff Classey, Charlotte, NC (US); Katherine Morris, Lake Wylie, SC (US); Michael Nystrom, San Jose, CA (US)

Correspondence Address: DIGITAL OPTICS CORPORATION, C/O LEE & MORSE, P.C., 3141 FAIRVIEW PARK DRIVE, SUITE 500, FALLS CHURCH, VA, 22042, US

(73) Assignee: TESSERA NORTH AMERICA

(21) Appl. No.: 11/984,435

(22) Filed: Nov. 16, 2007

Related U.S. Application Data
(60) Provisional application No. 60/859,519, filed on Nov. 17, 2006.

(51) Int. Cl. H04N 5/225

(52) U.S. Cl. 348/340; 348/E07.001

(57) ABSTRACT

A camera system may include an optics stack including first and second substrates secured together in a stacking direction, one of the first and seconds substrates including an optical element, a detector on a sensor substrate, and a feature reducing an amount of light entering at an angle greater than a field of view of the camera system from reaching the detector, the feature being on another of the first and second substrates.

### CROSS REFERENCE TO RELATED APPLICATION(S)

This application is related to provisional application Ser. No. 60/859,519, filed Nov. 17, 2006, the entire contents of which is hereby incorporated by reference.

### 1. FIELD OF THE INVENTION

The present invention is directed to a camera system and associated methods. More particularly, the present invention is directed to a camera system including internal structures for reducing noise, and associated methods.

### 2. BACKGROUND OF THE INVENTION

Cameras may include an optics stack of optical substrates secured to one another at planar portions thereof. A plurality of these optics stacks may be made simultaneously, e.g., at a wafer level.

Further, since the optical system may be formed of a vertical stack of substrates secured to one another, it may be that a housing for mounting lenses in the optical system, e.g., a barrel, could be eliminated. In order to provide appropriate spacing, including air gaps, between the substrates, standoffs or other spacing structures may be provided between the substrates. One type of spacing structure includes a substrate having holes thereon. Such a spacer substrate may be readily produced on a wafer level, and may be particularly useful for providing larger air gaps between substrates.

Depending on where sidewalls of the air gaps in the spacer substrate are located in the optics stack, they may aid in directing unwanted light onto the detector due to reflection off the sidewall, increasing noise. However, it may not be practical to make the spacer substrate out of a non-reflective material. While it may be sufficient to create a conventional housing simply out of an opaque material, opaque materials may still reflect light, which, for structures internal to the camera system, is undesirable.

Further, when the optics stack includes an array of lens systems, e.g., more than one lens on at least one surface of the optics stack, each for imaging light onto a corresponding active area in the detector, even light that is properly part of an image is incident on one active area detector may give rise to crosstalk when incident on another active area, increasing noise.

### SUMMARY OF THE INVENTION

The present invention is therefore directed to a camera system employing an optics stack and associated methods, which substantially overcome one or more of the problems due to the limitations and disadvantages of the related art.

It is therefore a feature of the present invention to provide an internal structure for reducing noise from reaching a detector of the camera system.

It is another feature of the present invention to provide internal sidewalls of a spacer that direct unwanted light away from the detector of the camera system.

It is still another feature of the present invention to provide an internal structure for reducing crosstalk between detectors of the camera system.

At least one of the above and other features and advantages of the present invention may be realized by providing a camera system, an optics stack including first and second substrates secured together in a stacking direction, one of the first and seconds substrates including an optical element, a detector on a sensor substrate; and a feature reducing an amount of light entering at an angle greater than a field of view of the camera system from reaching the detector, the feature being on another of the first and second substrates.

The optical element may be on the first substrate and the second substrate may be a spacer substrate providing an air gap between the optical element and the detector. The feature of the spacer substrate may be an angled sidewall that is continuous from an upper surface of the spacer substrate to a lower surface of the spacer substrate. The sidewall may define a smaller opening at the upper surface of the spacer substrate than at the lower surface of the spacer substrate. An anti-reflective coating or an absorptive coating may be on the sidewall. The feature of the spacer substrate may be a beveled sidewall. The sidewall may define a same size opening at the upper surface of the spacer substrate and at the lower surface of the spacer substrate, or may define a smaller opening at the upper surface of the spacer substrate than at the lower surface of the spacer substrate.

An absorptive coating or an anti-reflective coating on a sidewall adjacent the air gap. The spacer substrate may be formed of an optically absorbing material. The optically absorbing material may a polymeric material. The spacer substrate may be opaque. The spacer substrate may be a glass material. The spacer substrate may be an optically absorbing adhesive material.

The camera system may further include an absorbing layer interposed between a final surface and the sensor substrate, the absorbing layer configured to absorb light scattered by the sensor substrate. The camera system may further include a cover plate between the optics stack and the sensor substrate, wherein the absorbing layer is directly on the cover plate.

At least one of the above and other features and advantages of the present invention may be realized by providing a camera system, including an optics stack that itself includes first and second substrates secured together in a stacking direction, a surface of at least one of the first and second substrates including at least two lenses thereon, a detector on a sensor substrate, corresponding portions of the detector to receive an image from a corresponding lens of the at least two lenses, and a baffle between an upper surface of a last substrate of the optics stack and the sensor substrate.

The camera system may include a spacer substrate in between the first and second substrate. The spacer substrate may include a feature reducing an amount of light entering the optical system at an angle greater than a field of view of the optical system from reaching the detector.

The baffle may be in an indent on a bottom surface of the last substrate in the optics stack and/or on a bottom surface of the last substrate in the optics stack.

The camera system may include a cover plate attached to the sensor substrate. The baffle may be on the cover plate. The baffle may be between the cover plate and the last substrate in the optics stack.

At least one of the above and other features and advantages of the present invention may be realized by providing an optical module including: an optics stack including at least first, second and third substrates stacked in a stacking direction; the first and third substrates being provided with one or more optical features, respectively; and the second substrate being formed of an optically absorbing material.

At least one of the above and other features and advantages of the present invention may be realized by providing a method of forming an inchoate optical module, the method including: providing a first substrate having at least one optical feature; providing a patterned optically absorbing material in a solid form as a second substrate on the first substrate; and providing a third substrate having at least one optical feature on the second substrate to form an optics stack including the first, second and third substrates stacked in a stacking direction. For example, the optically absorbing material may be a polymeric material, e.g., a raw or pigmented polyimide.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1A illustrates a cross-sectional view of a plurality of camera systems in accordance with an exemplary embodiment of the present invention;

FIG. 1B illustrates a cross-sectional view of one of the camera systems of FIG. 1A;

FIG. 2A illustrates a cross-sectional view of a plurality of camera systems in accordance with another exemplary embodiment of the present invention;

FIG. 2B illustrates a cross-sectional view of one of the camera systems of FIG. 2A;

FIG. 3A illustrates a cross-sectional view of a plurality of camera systems in accordance with another exemplary embodiment of the present invention;

FIG. 3B illustrates a cross-sectional view of one of the camera systems of FIG. 3A;

FIG. 3C illustrates (in accordance with an exemplary embodiment of the present invention) a cross-sectional view of a camera system that is a variant to that of FIG. 3B;

FIG. 4 illustrates a cross-sectional view of a camera system in accordance with another exemplary embodiment of the present invention;

FIG. 5 illustrates a cross-sectional view of a camera system in accordance with another exemplary embodiment of the present invention;

FIG. 6 illustrates a cross-sectional view of a camera system in accordance with another exemplary embodiment of the present invention;

FIG. 7 illustrates a cross-sectional view of a camera system in accordance with another exemplary embodiment of the present invention; and

FIG. 8 illustrates a cross-sectional view of a camera system in accordance with another exemplary embodiment of the present invention.

### DETAILED DESCRIPTION

The present invention will now be described more fully hereinafter with reference to the accompanying drawings, in which preferred embodiments of the invention are shown. The invention may, however, be embodied in different forms and should not be construed as limited to the embodiments set forth herein. Rather, these embodiments are provided so that this disclosure will be thorough and complete, and will fully convey the concept of the invention to those skilled in the art.

In the drawings, the thickness of layers and regions may be exaggerated for clarity. It will also be understood that when a layer is referred to as being “on” another layer or substrate, it may be directly on the other layer or substrate, or intervening layers may also be present. Further, it will be understood that when a layer is referred to as being “under” another layer, it may be directly under, or one or more intervening layers may also be present. In addition, it will also be understood that when a layer is referred to as being “between” two layers, it may be the only layer between the two layers, or one or more intervening layers may also be present. Like numbers refer to like elements throughout. As used herein, the term “wafer” should be understood as meaning any substrate on which a plurality of components are formed which are to be vertically separated prior to final use. Further, as used herein, the term “camera system” should be understood as meaning any system including an optical imaging system relaying optical signals to a detector, e.g., an image capture system, which outputs information, e.g., an image. Dashed lines dividing a plurality of camera systems indicate lines along which the camera systems may be singulated, e.g., diced.

In accordance with embodiments of the present invention, a camera system utilizing lenses may include an optics stack having at least two substrates secured on a wafer level, the optics stack may include an optical imaging system. When spacers between substrates are reflective, they may reflect stray light further down the optical path of the system, which may increase stray light reaching the detector, increasing noise. Further, when an array of lenses is used for a single camera system, crosstalk may become an issue. By providing a blocking material at appropriate positions in the camera system, this stray light may be reduced or eliminated.

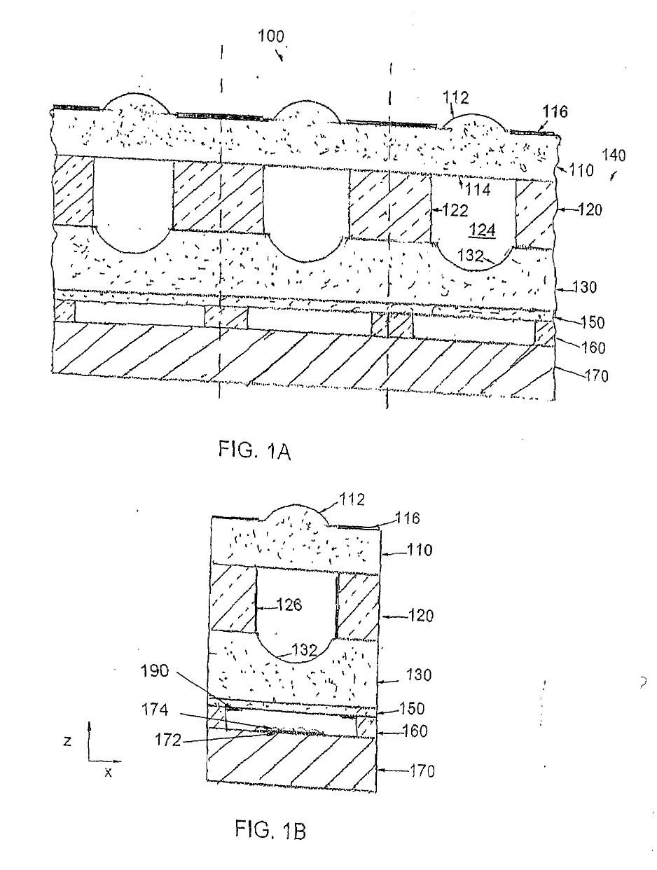

A plurality of camera systems 100 in accordance with an exemplary embodiment of the present invention is shown in FIG. 1A, and a corresponding singulated camera system 100 is shown in FIG. 1B. In FIGS. 1A and 1B, a single lens system may be used for all colors, and a color filter (e.g., a Bayer filter) may be provided directly on a detector array (i.e., an array of detectors/sensors, each of which is device for receiving light and generating an electrical signal representing an intensity of the received light). Alternatively, this lens system may be provided in any number, e.g., three or four, sub-cameras for each camera system, with a design and/or location of the color filters may be varied. Such lens stack designs for a camera may be found, for example, in commonly assigned, co-pending U.S. Provisional Patent Application No. 60/855,365 filed Oct. 31, 2006, U.S. patent application Ser. Nos. 11/487,580, filed Jul. 17, 2006, and 10/949,807, filed Sep. 27, 2004, and PCT Application Serial No. PCT/US2007/016156, filed Jul. 17, 2007, all of which herein are incorporated by reference in their respective entireties.

As illustrated in FIGS. 1A and 1B, the camera system 100 may include an optics stack 140 and a sensor substrate 170. The optics stack 140 may include a first substrate 110, a second substrate 120 and a third substrate 130 secured together as a stack. Relative to how FIGS. 1A and 1B are illustrated, the direction of stacking is vertical. The first substrate 110 may include a first refractive convex surface 112, which may assist in imaging the light input thereto. A second surface 114 of the first substrate 110 may be planar. The first substrate 110 may also include a coating 116 to serve as an aperture stop thereon, e.g., an opaque material, on the same surface as and surrounding the first refractive convex surface 112, as disclosed in U.S. Pat. No. 6,096,155, which is herein incorporated by reference in its entirety.

The second substrate 120 may be a spacer substrate, having sidewalls 122 defining air gaps 124 between the first and third substrate 110, 130. The second substrate 120 may be formed of an optically absorbing material, e.g., a raw polyimide (e.g., Kapton® from DuPont Electronics), a pigmented (e.g., black) polyimide, another type of polymer (e.g., PSK™ 2000 from Brewer Science Specialty Materials), black chrome, another type of metal, anodized metal, dry film, ceramic, a pigmented, e.g., black, adhesive, glass, silicon, photosensitive glass (e.g., Foturan® from Schott AG or PEG3 from Hoya Corporation of Tokyo, Japan), etc. These optically absorbing materials may be provided in sheets, i.e., in solid form, and punched, drilled, or otherwise patterned without necessarily using lithographic techniques. These optically absorbing materials may be flexible, conformal and/or compressible in the stacking direction, which may help facilitate the securing thereof to a surface that is not substantially planar, e.g., has surface roughness or partially covers a feature on the surface. Alternatively, the optical absorbing material may be spun, coated or laminated onto an adjacent substrate. Further, any of the optically absorbing materials may be further coated to further enhance their suppression properties.

The third substrate 130 may have a refractive, concave surface 132 therein. The concave surface 132 may flatten the field of the image, so that all image points may be imaged at the same plane onto an active area of a detector array on the sensor substrate 170. It should be noted that the optical designs of the optics stack 140 shown in FIGS. 1A, 1B and other embodiments provided herein are exemplary and that different locations, different numbers of optical surfaces, and different shapes of optical surfaces, including concave, convex, and aspheric surfaces may be incorporated into a particular optical design for a particular camera system 100.

A cover plate 150 and a standoff 160, providing accurate spacing between the optics stack 140 and the sensor substrate 170, may be provided between the optics stack 140 and the sensor substrate 170. The sensor substrate 170 may include a detector array 172 and an array of microlenses 174 on top of the detector array 172. The detector array 172 may be a CMOS photodiode array or a CCD array.

The cover plate 150 and the standoff 160 may seal the active area. The standoff 160 may be formed of any of the optically absorbing materials noted above. The cover plate 150 may be formed directly on the standoff 160. While the standoff 160 is illustrated as being a separate element from the sensor substrate 170 and the cover plate 150, the standoff may be integral with either one or both of the sensor substrate 170 and the cover plate 150. Further, while sidewalls of the standoff 160 are shown as being straight, e.g., formed by dicing or patterning, they may be angled in accordance with how the standoff 160 is formed, e.g., at an etch angle of a particular material used for the standoff 160. Additionally, the standoff 160 may be, e.g., an adhesive material that is precisely provided on one or both of the sensor substrate 170 and the cover plate 150, e.g., as disclosed in commonly assigned U.S. Pat. No. 6,669,803, which herein is incorporated by reference in its entirety.

The cover plate 150 may include a layer 190 of a highly effective absorbing material, e.g., a black metal such as black chrome. The layer 190 may be very thin, e.g., on the order of about 1000-2000 Å. The layer 190 may be on a surface of the cover plate 150 facing the sensor substrate 170. When light hits the highly effective absorbing material, most of the light will be absorbed. Further, when the light is incident on a smooth glass/material interface, the remaining light will reflect away from the sensor substrate 170. For example, when the layer 190 is provided on a bottom surface of the cover plate 150, light just outside the field of view may be more readily controlled, as apertures further from this surface may be less effective in reducing light scattered off a surface of the sensor substrate 170. Alternatively, when a cover plate is not employed, the layer 190 may be provided on a final surface of the optics stack 140.

As shown in FIGS. 1A and 1B, the substrates 110, 120 and 130 may have opposing planar surfaces with the optical elements 112 and 132, as well as an air gap 124, formed therebetween. The use of planar surfaces may be advantageous, since it may enable control of the tilt of all of the elements in the lens system. The use of planar surfaces may also allow stacking of the elements and bonding directly to the planar surfaces, which may facilitate wafer level assembly. For example, a purpose or role of the second substrate 120 may be that of a bonding layer. The planar surfaces may be left in the periphery around each element, or planar surfaces may be formed around the periphery of each lens element through deposition of suitable material.

The spacer wafer 120 may be formed, as disclosed, for example, in U.S. Pat. No. 6,669,803, which herein is incorporated by reference in its entirety. When the sidewalls 122 are straight, as shown in FIGS. 1A and 1B, stray light entering the camera system 100, i.e., at a higher angle than the field of view of the camera system may be reflected onto the active area on the sensor substrate 170. As shown in FIG. 1B, as an option, an absorptive coating 126 may be provided on the sidewalls 122 to help reduce the amount of stray light reflected towards the sensor substrate 170.

A method (in accordance with an exemplary embodiment of the present invention) of forming a plurality of first inchoate optical modules (or, in other words, a plurality of first precursors to, e.g., the camera systems 100) will now be discussed. Such a method may include: providing a first substrate having at least one optical element, e.g., sensor substrate 170 or substrate 130; forming a spacer, e.g., standoff 160 or spacer substrate 120, on the first substrate; providing a second substrate having a feature for reducing light at an angle greater than a filed of view from reaching the detector, e.g., the cover plate 150 having the absorbing material 190 thereon or substrate 120; and securing the first and second substrates in a stacking direction, i.e., the z-direction, in substantially planar regions thereof.

The spacer substrate 120 may be an optically absorbing material provided in a solid form, e.g., a polymeric material. Air gaps may be formed in the polymeric material before aligning the polymeric material with the first and third substrate to allow communication between the optical element and the detector. The thickness of the spacer substrate 120 may be chosen so as to position the at least one optical element of the optics stack 140 a desired distance in the stacking direction from the sensor substrate 170.

Additional second inchoate optical modules may be formed using additional substrates, e.g., forming the optics stack 140. These second inchoate optical modules may be secured in the stacking direction along substantially planar portions thereof with first inchoate optical modules before or after singulation of either the first and/or second optical modules.

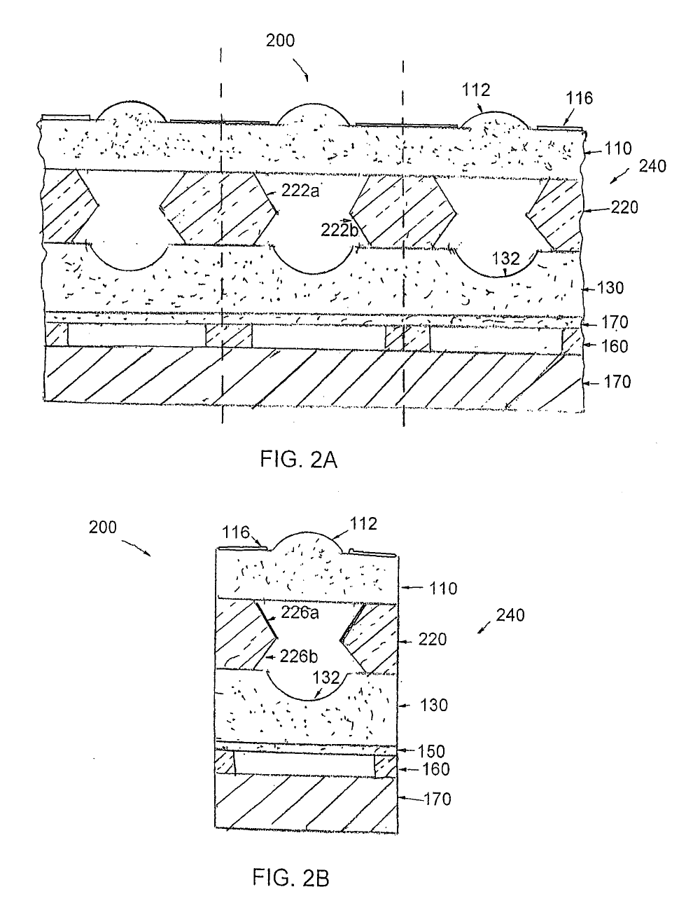

A camera system 200 according to another exemplary embodiment, as illustrated in FIGS. 2A and 2B, may include an optics stack 240 and the sensor substrate 170. In the camera system 200, a spacer substrate 220 may have beveled sidewalls 222a, 222b. Such beveled sidewalls may be realized by anisotropic wet etching from both a top and bottom surface of the substrate, e.g., a silicon substrate.

Even without an optional coating 226a, shown in FIG. 2B, stray light incident on the upper sidewall 222a may be reflected back towards the first substrate 110. The coating 226a may further enhance the removal of stray light from the camera system 200, and may be reflective or absorptive. The coating 116 on the first substrate 110 may have an anti-reflective property or may be absorptive. The lower sidewall 222b may have an optional coating 226b thereon, which may also be anti-reflective or absorptive. Other elements of FIGS. 2A and 2B are the same as those in FIGS. 1A and 1B, and detailed description thereof is omitted.

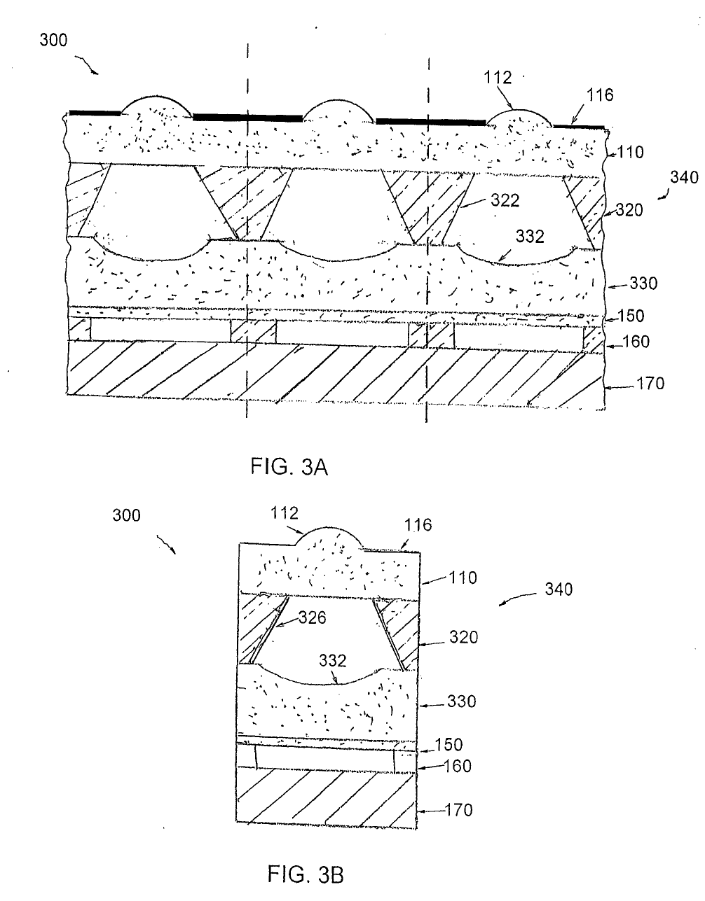

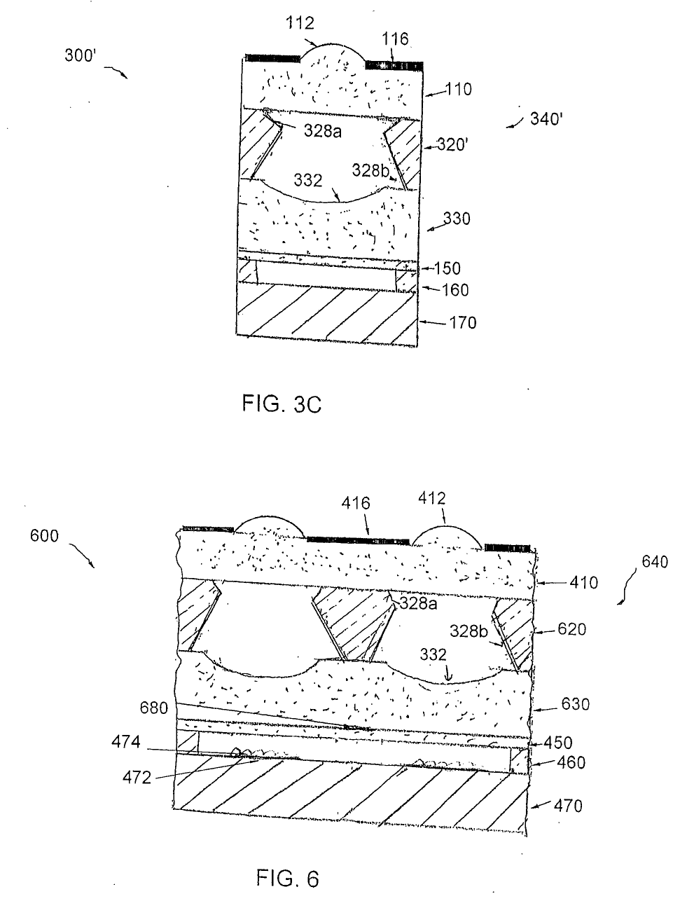

A camera system 300 according to another exemplary embodiment, as illustrated in FIGS. 3A and 3B, may include an optics stack 340 and a sensor substrate 170. In the camera system 300, a spacer substrate 320 may have a steeply angled sidewall 322. Relative to FIGS. 3A and 3B, in a vertical direction moving from top to bottom, sidewalls 322 can be described as tapering outward. In a vertical direction moving from bottom to top, sidewalls 322 can be described as tapering inward. Such a sidewall may be realized by wet etching from a bottom surface of the substrate.

Even without a coating 326, shown in FIG. 3B, the sidewall 322 may allow the light to miss the active area of the sensor substrate 170. The coating 326 may further enhance the removal of stray light from the camera system 300, and may be anti-reflective or absorptive. Further, by increasing a size of an opening defined by sidewalls 322 from an upper surface of the spacer substrate to a lower surface of the spacer substrate, the spacer substrate 320 may further effectively act as an aperture stop when the lens diameter of the refractive convex element 112 on the first substrate 110 is smaller than the lens diameter of a refractive concave element 332 on a third substrate 330. Other elements of FIGS. 3A and 3B are the same as those in FIGS. 1A and 1B, and detailed description thereof is omitted.

In a camera system 300′, an alternative combining aspects of FIGS. 2B and 3B is illustrated in FIG. 3C (according to another exemplary embodiment of the present invention). Rather than meeting at a vertex at a vertical substantially halfway point as shown in FIGS. 2A and 2B, FIG. 3C illustrates beveled sidewalls 328a, 328b, that meet at a vertex closer to a first substrate 410 than a halfway point between the substrate 410 and a substrate 430. Alternatively, the beveled sidewalls 328a, 328b may meet at a vertex closer to the third substrate 330. Such sidewalls 328a, 328b may be readily formed on a wafer level, e.g., by etching for different times from different surfaces of the substrate. The spacer wafer 320′ may provide the enhanced reflectivity out of the camera system 300′, and/or an appropriate aperture throughout an optics stack 340′. The sidewall 328a may have a coating thereon, e.g., coating 226a, and the sidewall 328b may have a coating thereon, e.g., coating 226b or 326.

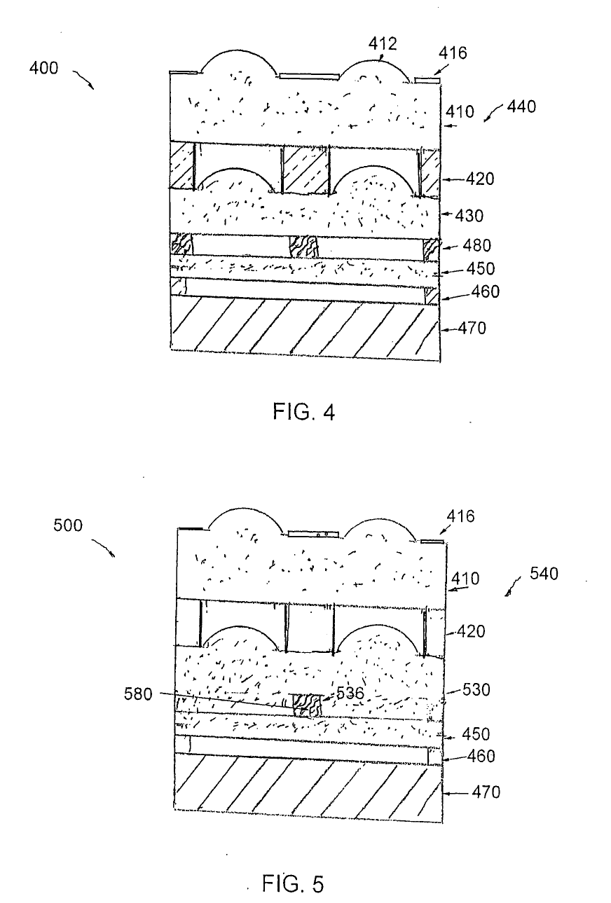

A camera system 400 including a plurality of lenses, e.g., four lenses arranged in a 2×2 array, on at least one surface of an optics stack 440 according to another exemplary embodiment of the present invention is illustrated in FIG. 4. The optics stack 440 may include a first substrate 410, a second substrate 420 and a third substrate 430. The first substrate 410 may include a first convex refractive surface 412 and an opaque material 416 on an upper surface. The second substrate 420 may be a spacer substrate, and may include a coating 126 on sidewalls thereof. An opaque or absorptive material 480 may be provided between the optics stack 440 and a cover plate 450, which, in turn, may be secured to a sensor substrate 470 via standoffs 460. The sensor substrate 470 may include a detector array 472 and microlens arrays 474 on top of the detector array 472, for each of the lenses in the lens array. The detector array 472 may be a CMOS photodiode array or a CCD array. The opaque or absorptive material 480 may be provided on the third substrate 430 or on the cover plate 450.

The opaque or absorptive material 480 may be patterned and etched, and may be formed of any of the optically absorbing materials noted above. For example, the opaque or absorptive material 480 may be a polymer, e.g., SU-8, that can be patterned lithographically to controlled thicknesses, e.g., about 50-100 microns. However, since such polymers may be transmissive, in order to reduce stray light, the polymer may be coated with an opaque material or may be dyed to become absorptive itself. Such standoffs 460 and/or material 480 may be formed as disclosed, for example, in commonly assigned U.S. Pat. No. 5,912,872 and U.S. Pat. No. 6,096,155, all of which herein are incorporated by reference in their respective entireties. Finally, the opaque or absorptive material 480 may be an adhesive or a solder.

A camera system 500 including an array of lenses on at least one surface of an optics stack 540 according to another exemplary embodiment of the present invention is illustrated in FIG. 5. The optics stack 540 may include the first substrate 410, the second substrate 420 and a third substrate 530. Here, instead of providing an opaque or absorptive material between the third substrate 530 and the cover plate 450, a bottom surface of the third substrate 530 may have a recess or an indent 536 therein formed by, e.g., dicing or etching. This indent 536 may be filled with opaque or absorptive material 580. Alternatively or additionally, an upper surface and/or a lower surface of the cover plate 450 may have an indent therein, which may be filled with the opaque or absorptive material 580. As a further alternative, the cover plate 450 may be removed from the camera system 500, e.g., with the third substrate 530 serving to seal the active area of the sensor substrate 470.

A camera system 600 including an array of lenses on at least one surface of an optics stack 640 according to another exemplary embodiment of the present invention is illustrated in FIG. 6. The optics stack 640 may include the first substrate 410, a second substrate 620 and a third substrate 630. In this particular embodiment, lenses 332 on the third substrate 630 may have larger diameters than lenses 412 on the first substrate 410. As can be seen in FIG. 6, when using a highly effective absorbing material, e.g., a metal, a very thin layer 680, e.g., on the order of about 1000-2000 Å, may be provided, e.g., on a bottom surface of the final substrate in the optics stack 640, e.g., on a bottom surface of the third substrate 630, or on an upper surface of the cover plate 450, to decrease crosstalk.

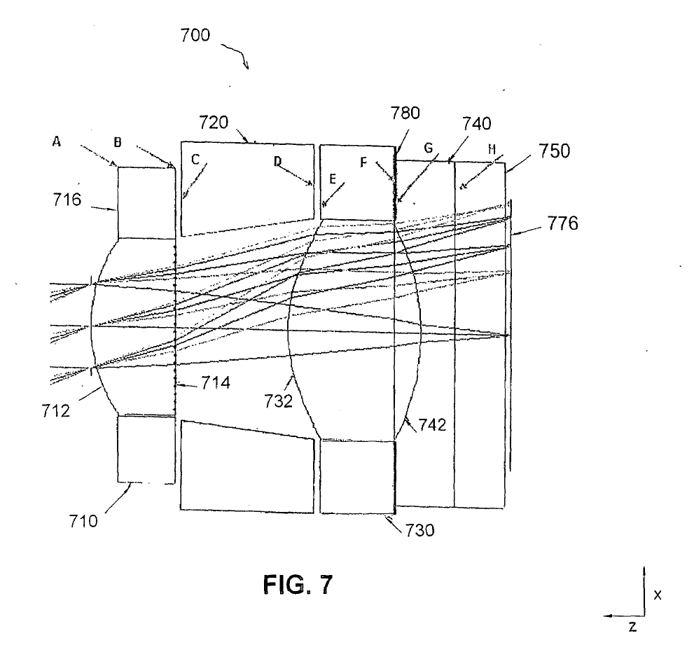

A camera system 700 including according to another exemplary embodiment of the present invention is illustrated in FIG. 7. While the orientation of the camera system 700 illustrated in FIG. 7 is rotated with respect to that shown in FIGS. 1A, 1B, 2A, 2B, 3A, 3B, 3C and 4-6, the stacking direction is still along the z-axis, i.e., is still vertical.

As can be seen in FIG. 7, an optics stack may include a first substrate 710, a second substrate 720, a third substrate 730, and a fourth substrate 740. Surface A of the first substrate 710 may include a convex refractive surface 712 and an aperture stop 716. Surface B of the first substrate 710 may include a diffractive lens 714. The second substrate 720, having surfaces C and D, may be a spacer wafer in accordance with another exemplary embodiment of the present invention. Surface E of the third substrate 730 may include another convex refractive surface 732. Surface F of the third substrate 730 may include a metal layer 780 thereon for further blocking stray light. Surface G of the fourth substrate 730 may include a refractive, concave surface 432 therein. The cover plate 750 and an active area 776 of the detector are also illustrated. Surface H of the cover plate 750 may be planar.

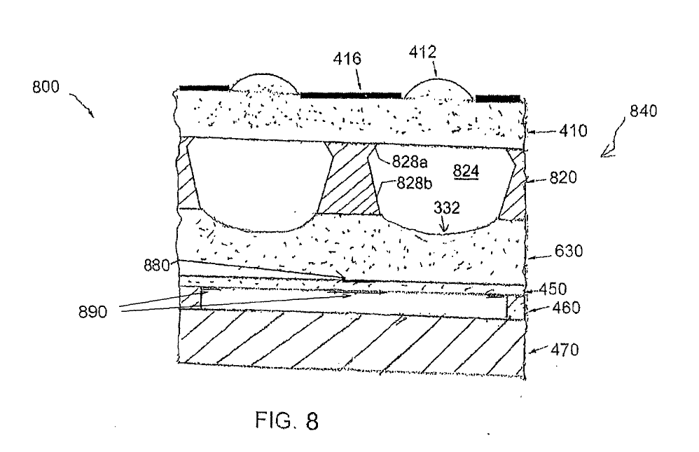

A camera system 800 including an array of lenses on at least one surface of an optics stack 840 according to another exemplary embodiment of the present invention is illustrated in FIG. 8. Whereas, relative to a horizontal line of reference, FIGS. 2A, 2B, 3C and 6 are illustrated with air gaps whose beveled sidewalls are convex, air gaps 824 in FIG. 8 are illustrated with beveled sidewalls 828a, 828b, that can be described as concave.

The optics stack 840 may include the first substrate 410, a second substrate 820 and a third substrate 630. In this particular embodiment, lenses 332 on the third substrate 630 may have larger diameters than lenses 412 on the first substrate 410. The beveled sidewalls 828a, 828b are illustrated as meeting at a vertex closer to a first substrate 410 than a halfway point between the substrate 410 and a substrate 630. Alternatively, the vertex could be located a vertical substantially halfway point, or at a point closer to the substrate 610 than to the substrate 410. Such sidewalls 828a, 828b may be readily formed on a wafer level, e.g., by etching for different times from different surfaces of the substrate. The spacer wafer 820 may provide the enhanced reflectivity out of the camera system 800, and/or an appropriate aperture throughout an optics stack 840. The sidewall 828a may have a coating thereon, e.g., coating 226a, and the sidewall 828b may have a coating thereon, e.g., coating 226b or 326.

As can be seen in FIG. 8, when using a highly effective absorbing material, e.g., a black metal, a very thin layer 880, e.g., on the order of about 1000-2000 Å, may be provided to decrease crosstalk. The layer 880 may be provided, e.g., on a bottom surface of the final substrate in the optics stack 840, e.g., on a bottom surface of the third substrate 630, and/or a layer 890 may be provided on either surface of the cover plate 450, to decrease crosstalk. In particular, when light hits the highly effective absorbing material, most of the light will be absorbed. Further, when the light is incident on a glass/material interface that is smooth, the remaining light will reflect away form the sensor. For example, when the layer 890 is provided on a bottom surface of the cover plate 450, light just outside the field of view may be more readily controlled, as apertures further from this surface may be less effective in reducing light scattered off a surface of the sensor substrate 470.

A method (in accordance with an exemplary embodiment of the present invention) of forming a plurality of first inchoate optical modules (or, in other words, a plurality of first precursors to, e.g., the camera systems 800) will now be discussed. Such a method may include: providing a first substrate having at least one optical feature, e.g., sensor substrate 470; forming a standoff, e.g., 460, on the first substrate; forming a black chrome layer 890, on (e.g., directly on) a second substrate, e.g., the cover plate 450; and disposing the second substrate on (e.g., directly on) the standoff with the side of the second substrate having the black chrome layer being oriented to face the first substrate.

In the drawings, the sidewalls defining air gaps have been illustrated as substantially straight line segments. Alternatively, the sidewalls may be curved. Also, the sidewall surfaces may have a relatively rough surface texture. Further, any of the blocking features illustrated in an embodiment may be used in conjunction with other embodiments.

Thus, in accordance with embodiments of the present invention, by providing a blocking material at appropriate positions in the camera system, this stray light may be reduced or eliminated.

Exemplary embodiments of the present invention have been disclosed herein, and although specific terms are employed, they are used and are to be interpreted in a generic and descriptive sense only and not for purpose of limitation. For example, while the substrates in the optics stack may all be the same material or may be different materials. Additionally, some or all of the optical elements in the optics stack may be replicated and be in plastic, rather than transferred to the substrate. Accordingly, it will be understood by those of ordinary skill in the art that various changes in form and details may be made without departing from the spirit and scope of the present invention as set forth in the following claims.

What is claimed is:

1. A camera system, comprising:
an optics stack including first and second substrates secured together in a stacking direction, one of the first and seconds substrates including an optical element;
a detector on a sensor substrate; and
a feature reducing an amount of light entering at an angle greater than a field of view of the camera system from reaching the detector, the feature being on another of the first and second substrates.

2. The camera system as claimed in claim 1, wherein the optical element is on the first substrate and the second substrate is a spacer substrate providing an air gap between the optical element and the detector.

3. The camera system as claimed in claim 2, wherein the feature of the spacer substrate is an angled sidewall that is continuous from an upper surface of the spacer substrate to a lower surface of the spacer substrate.

4. The camera system as claimed in claim 3, wherein the sidewall defines a smaller opening at the upper surface of the spacer substrate than at the lower surface of the spacer substrate.

5. The camera system as claimed in claim 3, further comprising one of an anti-reflective coating on the sidewall and an absorptive coating on the sidewall.

6. The camera system as claimed in claim 2, wherein the feature of the spacer substrate is a sidewall that is beveled.

7. The camera system as claimed in claim 6, wherein, the sidewall defines a same size opening at the upper surface of the spacer substrate and at the lower surface of the spacer substrate.

8. The camera system as claimed in claim 2, wherein the sidewall defines an opening at the upper surface of the spacer substrate that is different than an opening at the lower surface of the spacer substrate.

9. The camera system as claimed in claim 2, further comprising one of an absorptive coating and an anti-reflective coating on a sidewall adjacent the air gap.

10. The camera system as claimed in claim 2, wherein the spacer substrate is formed of an optically absorbing material.

11. The camera system as claimed in claim 10, wherein the optically absorbing material is a polymeric material.

12. The camera system as claimed in claim 10, wherein the spacer substrate is opaque.

13. The camera system as claimed in claim 10, wherein the spacer substrate is a glass material.

14. The camera system as claimed in claim 1, wherein the feature of the second substrate is that the second substrate is formed of an optically absorbing material, the second substrate also representing a bonding layer.

15. The camera system as claimed in claim 1, further comprising an absorbing layer interposed between a final surface and the sensor substrate, the absorbing layer configured to absorb light scattered by the sensor substrate.

16. The camera system as claimed in claim 15, further comprising a cover plate between the optics stack and the sensor substrate, wherein the absorbing layer is directly on the cover plate.

17. A camera system, comprising:
an optics stack including first and second substrates secured together in a stacking direction, a surface of at least one of the first and second substrates including at least two lenses thereon;
active areas on a sensor substrate, corresponding active areas adapted to receive an image from a corresponding lens of the at least two lenses; and
a baffle between an upper surface of a last substrate of the optics stack and the sensor substrate.

18. The camera system as claimed in claim 17, further comprising a spacer substrate in between the first and second substrates.

19. The camera system as claimed in claim 18, wherein the spacer substrate includes a feature reducing an amount of light entering the optical system at an angle greater than a field of view of the camera system from reaching the detector.

20. The camera system as claimed in claim 17, wherein the baffle is in an indent on a bottom surface of the last substrate in the optics stack.

21. The camera system as claimed in claim 17, wherein the baffle is on a bottom surface of the last substrate in the optics stack.

22. The camera system as claimed in claim 17, further comprising a cover plate attached to the sensor substrate, wherein the baffle is on the cover plate.

23. The camera system as claimed in claim 22, wherein the baffle is between the cover plate and the last substrate in the optics stack.

24. A method of forming an inchoate optical module, the method comprising:
providing a first substrate having at least one optical feature;
providing a patterned optically absorbing material in a solid form as a second substrate; and
providing a third substrate having at least one optical feature on the second substrate to form an optics stack including the first, second and third substrates stacked in a stacking direction.

25. The method as claimed in claim 24, wherein the optically absorbing material is a polymeric material.
